(19) United States
(12) Patent Application Publication
(10) Pub. No.: US 2025/0157015 A1
(43) Pub. Date: May 15, 2025

(54) VIDEO NOISE DETECTION METHOD AND APPARATUS, AND DEVICE AND MEDIUM

(71) Applicant: Beijing Zitiao Network Technology Co., Ltd., Haidian District, Beijing (CN)

(72) Inventor: Qiubo CHEN, Beijing (CN)

(21) Appl. No.: 18/725,617

(22) PCT Filed: Jan. 17, 2023
(86) PCT No.: PCT/CN2023/072550

§ 371 Date: Jun. 28, 2024

(30) Foreign Application Priority Data
Jan. 27, 2022 (CN) 202210102693.X

(51) Int. Cl. G06T 7/00; G06T 3/02; G06T 7/11; G06T 7/40

(52) U.S. Cl. CPC G06T 7/0002; G06T 3/02; G06T 7/11; G06T 7/40; G06T 2207/10016; G06T 2207/30168

(57) ABSTRACT

The present disclosure relates to a video noise detection method and apparatus, and a device and a medium. The video noise detection method includes: extracting a first video frame and a second video frame from a target video, wherein the first video frame and the second video frame are adjacent video frames; performing differential processing on the first video frame and the second video frame, so as to obtain an inter-frame differential image between the first video frame and the second video frame; performing flat area detection on the first video frame and the second video frame, to obtain an intersection of flat areas in the first video frame and the second video frame; and calculating a time-domain noise value corresponding to the first video frame by using pixel information of the intersection of the flat areas in the inter-frame differential image.

### CROSS-REFERENCE TO RELATED APPLICATIONS

The present application is based on and claims the priority to the Chinese patent application No. 202210102693.X entitled “VIDEO NOISE DETECTION METHOD AND APPARATUS, AND DEVICE AND MEDIUM” filed on Jan. 27, 2022, the disclosure of which is incorporated by reference herein in its entirety.

### TECHNICAL FIELD

The present disclosure relates to the technical field of video processing, and in particular, to a video noise detection method and apparatus, and a device and a medium.

### BACKGROUND

Currently, users are accustomed to capturing a video with a built-in camera of a smartphone. However, due to performance limitations of the built-in camera of the smartphone, some types of videos captured with the built-in camera of the smartphone may have strong noise, which seriously affects watching experience for the captured video.

In order to reduce the influence of the video noise on the viewing experience, it is needed to identify the noise of the captured video using a noise detection algorithm, and then remove the video noise. However, the noise detection algorithm provided in the industry at present cannot take into account both accuracy and real time, and therefore cannot meet the requirement for real-time processing of the video noise.

### SUMMARY

To solve the above technical problem or at least partially solve it, the present disclosure provides a video noise detection method and apparatus, and a device and a medium.

In a first aspect, an embodiment of the present disclosure provides a video noise detection method, comprising:
extracting a first video frame and a second video frame from a target video, wherein the first video frame and the second video frame are adjacent video frames;
performing differential processing on the first video frame and the second video frame, to obtain an inter-frame differential image between the first video frame and the second video frame;
performing flat area detection on the first video frame and the second video frame, to obtain an intersection of flat areas in the first video frame and the second video frame; and
calculating a time-domain noise value corresponding to the first video frame by using pixel information of the intersection of the flat areas in the inter-frame differential image.

In a second aspect, an embodiment of the present disclosure provides a video noise detection apparatus, comprising:
an extracting unit configured to extract a first video frame and a second video frame from a target video, wherein the first video frame and the second video frame are adjacent video frames;
a processing unit configured to perform differential processing on the first video frame and the second video frame, to obtain an inter-frame differential image between the first video frame and the second video frame;
an intersection determining unit configured to perform flat area detection on the first video frame and the second video frame, to obtain an intersection of flat areas in the first video frame and the second video frame; and
a calculating unit configured to calculate a time-domain noise value corresponding to the first video frame by using pixel information of the intersection of the flat areas in the inter-frame differential image.

In a third aspect, an embodiment of the present disclosure provides a computing device, comprising: a processor; a memory configured to store executable instructions, wherein the processor is configured to read the executable instructions from the memory and execute the executable instructions to implement the video noise detection method as described above.

In a fourth aspect, the present disclosure provides a computer-readable storage medium having thereon stored a computer program which, when executed by a processor, causes the processor to implement the video noise detection method as described above.

In a fifth aspect, the present disclosure provides a computer program, comprising: instructions which, when executed by a processor, cause the processor to perform any of the video noise detection methods according to the embodiments of the present disclosure.

### BRIEF DESCRIPTION OF THE DRAWINGS

In conjunction with the accompanying drawings and with reference to the following DETAILED DESCRIPTION, the above and other features, advantages, and aspects of the embodiments of the present disclosure will become more apparent. Throughout the drawings, same or similar reference numbers indicate same or similar elements. It should be understood that the drawings are schematic and components and elements are not necessarily drawn to scale.

FIG. 1 is a flow diagram of a video noise detection method according to some embodiments of the present disclosure;

FIG. 2 is a flow diagram of obtaining an inter-frame differential image according to some embodiments of the present disclosure;

FIG. 3 is a flow diagram of determining a common minimum flat area according to some embodiments of the present disclosure;

FIG. 4 is a flow diagram of determining a time-domain noise value according to some embodiments of the present disclosure;

FIG. 5 is a flow diagram of a video noise detection method according to some other embodiments of the present disclosure;

FIG. 6 is a schematic diagram of a video noise detection apparatus according to an embodiment of the present disclosure;

FIG. 7 shows a schematic structural diagram of a computing device according to an embodiment of the present disclosure.

### DETAILED DESCRIPTION

The embodiments of the present disclosure will be described in more detail below with reference to the accompanying drawings. While certain embodiments of the present disclosure are shown in the drawings, it should be understood that the present disclosure may be implemented in various forms and should not be construed as limited to the embodiments set forth herein, which are provided for a more complete and thorough understanding of the present disclosure instead. It should be understood that the drawings and the embodiments of the present disclosure are for exemplary purposes only and are not intended to limit the scope of protection of the present disclosure.

It should be understood that various steps recited in method implementations of the present disclosure may be performed in a different order, and/or performed in parallel. Furthermore, the method implementations may include additional steps and/or omit performing the illustrated steps. The scope of the present disclosure is not limited in this respect.

The term “including” and variations thereof used herein are intended to be open-ended, i.e., “including but not limited to”. The term “based on” is “at least partially based on”. The term “one embodiment” means “at least one embodiment”; the term “another embodiment” means “at least one other embodiment”; and the term “some embodiments” means “at least some embodiments”. Definitions related to other terms will be given in the following description.

It should be noted that the concepts “first”, “second”, and the like mentioned in the present disclosure are only used for distinguishing different devices, modules or units, and are not used for limiting the order or interdependence of functions performed by the devices, modules or units.

It should be noted that modification of “a” or “a plurality” mentioned in this disclosure is intended to be illustrative rather than restrictive, and that those skilled in the art should appreciate that it should be understood as “one or more” unless otherwise explicitly stated in the context.

Names of messages or information exchanged between a plurality of devices in the implementations of the present disclosure are for illustrative purposes only, and are not intended to limit the scope of the messages or information.

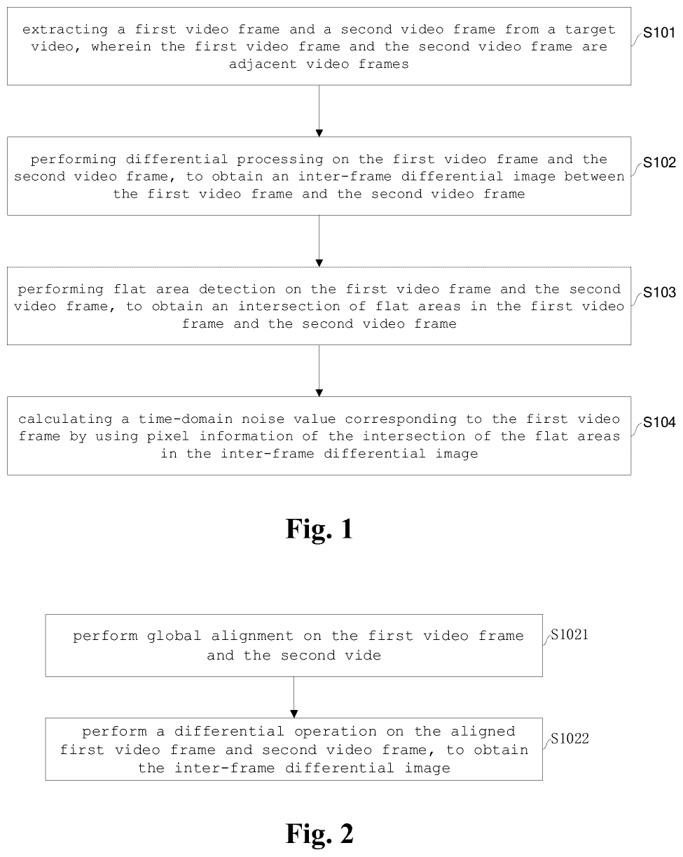

FIG. 1 is a flow diagram of a video noise detection method according to some embodiments of the present disclosure. As shown in FIG. 1, the video noise detection method according to the embodiments of the present disclosure comprises steps S101 to S104.

It should be noted that the video noise detection method according to the embodiments of the present disclosure may be executed by a computing device. The computing device includes, but is not limited to, an electronic device such as a smartphone, laptop computer, personal digital assistant (PDA), portable android device (PAD), portable multimedia player (PMP), vehicle-mounted terminal (e.g., vehicle-mounted navigation terminal), and wearable device, and may also include a server.

The video noise detection method comprises Step S101: extracting a first video frame and a second video frame from a target video, wherein the first video frame and the second video frame are adjacent video frames.

In the embodiment of the present disclosure, the computing device may acquire a target video. For example, if the computing device is an electronic device such as a smartphone, the computing device may form a target video to be processed by capturing images with a built-in camera. For another example, if the computing device is a server, the computing device may receive a target video to be processed that is sent by the electronic device over a network. Of course, the computing device may also read a locally stored target video and process the target video.

The target video may be a video in an original format or a video subjected to encoding processing, which is not particularly limited in the embodiment of the present disclosure. For example, if the computing device is an electronic device and the target video is a target video to be processed that is captured by the electronic device, the target video is preferably a video in an original format. If the computing device is a server and the target video is a video to be processed that is sent over a network, in order to ensure real time of video transmission, the target video is preferably a video subjected to encoding processing.

After acquiring the target video, the computing device extracts a video frame in the target video. Specifically, the computing device will extract a first video frame and a second video frame in the target video. The first video frame and the second video frame are adjacent video frames. In practical applications, the first video frame may be a succeeding video frame in the two adjacent video frames, and the second video frame may be a preceding video frame in the two adjacent video frames. It should be noted that the first video frame and the second video frame have the same resolution in horizontal and vertical directions.

The video noise detection method comprises Step S102: performing differential processing on the first video frame and the second video frame, to obtain an inter-frame differential image between the first video frame and the second video frame.

In some embodiments of the present disclosure, the performing differential processing on the first video frame and the second video frame is to subtract gray values of pixels at corresponding positions of the first video frame and the second video frame, respectively, to obtain pixel gray differences. That is, the inter-frame differential image between the first video frame and the second video frame is an image formed by the pixel gray differences in a ranking order of the corresponding pixels in the first video frame and the second video frame.

In some specific applications, when capturing the target video, a capturing device (e.g., a smartphone with a built-in camera) moves rapidly relative to a captured object, so that image contents of the captured first video frame and second video frame are not the same. If the differential processing is directly performed on the first video frame and the second video frame, the obtained frame differential image may be unable to show the pixel gray differences of the captured object (i.e. the rapidly moving object) in the two video frames.

FIG. 2 is a flow diagram of obtaining an inter-frame differential image according to some embodiments of the present disclosure. As shown in FIG. 2, to address the foregoing problem, in some embodiments of the present disclosure, when the above step S102 is performed by the computing device, steps S1021-S1022 may be included.

Step S1021: performing global alignment on the first video frame and the second video frame, to obtain aligned first video frame and second video frame.

The performing global alignment on the first video frame and the second video frame is, by taking one of the first video frame and the second video frame as a reference, to match image pixel content representative of a certain object in the other video frame with image pixel content representative of the same object in the video frame as the reference.

In the embodiment of the present disclosure, since the first video frame is a video frame to be processed and the second video frame is a reference video frame, by taking the second video frame as a reference and the first video frame as a video frame to be aligned, the first video frame is processed to obtain the aligned first video frame and second video frame.

Specifically, in order to perform global alignment on the first video frame and the second video frame, it is possible to select feature areas in the first video frame and the second video frame, and match the feature areas. After matching the feature areas in the first video frame and the second video frame, a coordinate transformation relation of the target object represented by the feature areas in the two video frames can be determined according to pixel coordinates of the feature areas in the two video frames.

After the coordinate transformation relation of the target object in the first image frame and the second image frame is determined, affine transformation is performed on the first image frame according to the coordinate transformation relation, then the global alignment of the first image frame relative to the second image frame can be achieved.

In some embodiments of the present disclosure, the step S1021 of performing global alignment on the first video frame and the second video frame, to obtain aligned first video frame and second video frame may specifically include steps S1021A-S1021B.

Step S1021A: performing luminance alignment processing on the first video frame and the second video frame, to obtain luminance-aligned first video frame and second video frame.

In practical applications, due to real-time changes in ambient light intensity, light irradiating the target object may be different in intensity, causing different luminance of pixels of the target object represented in the first video frame and the second video frame, and then causing a system error to be brought into the inter-frame differential image between the first video frame and the second video frame.

To avoid the above problem, in some embodiments of the present disclosure, before global phase alignment is performed on the first video frame and the second video frame, it is possible to perform luminance alignment on the first video frame and the second video frame first. The performing luminance alignment on the first video frame and the second video frame is to adjust maximum luminance of the first video frame and the second video frame to be consistent, or adjust black and white fields in the first video frame and the second video frame to be consistent.

In some embodiments of the present disclosure, in order to perform luminance alignment processing on the first video frame and the second video frame, gray histograms of pixels in the first video frame and the second video frame are obtained first, and then, according to the gray histograms of the first video frame and the second video frame, gray values of the pixels in the first video frame are adjusted according to a preset same-direction adjustment rule, such that luminance of the pixels in the first video frame is adjusted according to the adjustment rule, and such that luminance of the first video frame and luminance of the second video frame is in alignment. In a specific embodiment, the luminance alignment of the first video frame and the second video frame may be behaved as substantially same distribution styles of the gray histograms of the two.

Step S1021B: performing a phase alignment operation on the luminance-aligned first video frame and the second video frame, to obtain a coordinate transformation relation between the first video frame and the second video frame.

The computing device may select feature areas in the first video frame and the second video frame and match the feature areas. After matching the feature areas in the first video frame and the second video frame, the computing device determines the coordinate transformation relation of the target object represented by the feature areas in the two video frames according to pixel coordinates of the feature areas in the two video frames.

In some embodiments of the present disclosure, in order to increase the processing speed, when the computing device performs the phase alignment operation on the first video frame and the second video frame, steps B1-B4 may be included.

B1: performing down-sampling of a preset multiple on the luminance-aligned first video frame and second video frame, to obtain down-sampled first video frame and down-sampled second video frame.

B2: performing a phase alignment operation on the down-sampled first video frame and the down-sampled second video frame, to obtain a rotation matrix and a down-sampling translation vector.

B3: multiplying the down-sampling translation vector by the preset multiple, to obtain an original offset.

After the coordinate transformation relation between the first video frame and the second video frame is determined by using the foregoing method, step S1021C may be performed.

Step S1021C: performing affine transformation on the luminance-aligned first video frame by using the coordinate transformation relation, to obtain affine-transformed first video frame.

After the coordinate transformation relation is obtained, affine transformation, i.e., rotation and/or translation transformation, is performed on the luminance-aligned first video frame by using the coordinate transformation relation, then the affine-transformed first video frame can be obtained.

Step S1022: performing a differential operation on the aligned first video frame and second video frame, to obtain the inter-frame differential image.

After the aligned first video frame and second video frame are obtained, the differential operation is performed by using pixels representative of the same object in the aligned first video frame and second video frame, then the inter-frame differential image can be obtained.

It should be noted that when the step S1022 is performed, it may arise that certain pixels in the first video frame and the second video frame do not have corresponding pixels for the differential operation, and the differential operation is performed on only part of the pixels of the first video frame and the second video frame, to obtain the inter-frame differential image.

In the foregoing embodiment of the present disclosure, the alignment performed on the first video frame and the second video frame is the global alignment. The global alignment is particularly suitable for processing a target video formed by capturing a stationary target object by a mobile capturing device.

In other embodiments of the present disclosure, the alignment performed on the first video frame and the second video frame may also be local alignment. That is, when the alignment is performed on the first video frame and the second video frame, alignment processing is performed on only part of pixel areas in the first video frame. After obtaining the aligned first video frame and second video frame by performing local alignment processing, a differential operation may be performed on the first video frame and the second video frame, to obtain the inter-frame differential image.

The video noise detection method comprises Step S103: performing flat area detection on the first video frame and the second video frame, to obtain an intersection of flat areas in the first video frame and the second video frame.

The flat areas in the embodiment of the present disclosure are areas where changes in image pixels in the first video frame and the second video frame are relatively gentle. For example, the flat areas may be areas having a specific color and luminance in the first video frame and the second video frame.

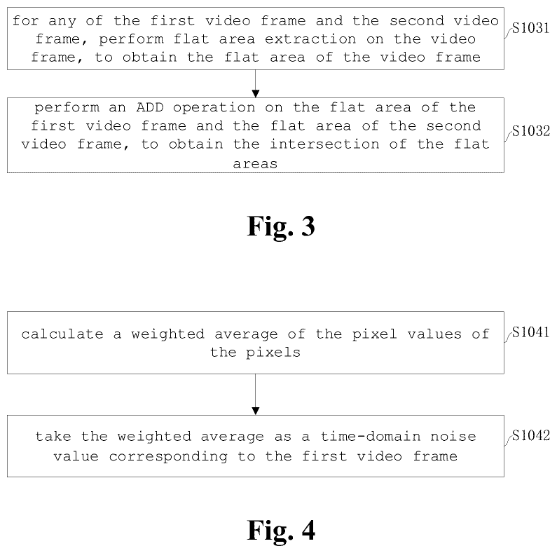

FIG. 3 is a flow diagram of determining a common minimum flat area according to some embodiments of the present disclosure. As shown in FIG. 3, in some embodiments of the present disclosure, the step S103 of performing flat area processing on the first video frame and the second video frame, to obtain an intersection of flat areas in the first video frame and the second video frame may include steps S1031 to S1032.

Step S1031: for any of the first video frame and the second video frame, performing flat area extraction on the video frame, to obtain the flat area of the video frame.

In the embodiment of the present disclosure, the performing flat area processing on any of the first video frame and the second video frame is to perform flat area processing on the first video frame and the second video frame, respectively.

In some embodiments, the performing flat area processing on the first video frame and the second video frame, to obtain the flat area of the video frame may include steps S1031A-S1031C.

Step S1031A: performing image segmentation on the video frame, to obtain a plurality of image areas of the video frame.

In some embodiments, by performing image segmentation on the video frame in the embodiment of the present disclosure, a gradient image of the video frame may be obtained, the gradient image being an image formed by gradients. Subsequently, segmentation is performed on the video frame image according to the gradient image, to obtain a plurality of image areas in the video frame. The gradient image is an image determined according to a pixel gray difference between adjacent pixels of the video frame. The performing segmentation on the video frame image according to the gradient image is to select a pixel greater than a preset value in the gradient image as an edge of a block image, and determine the plurality of image areas of the video frame based on the edge of the block image.

Step S1031B: determining a texture parameter of each of the image areas.

After the plurality of image areas are obtained, each of the image areas may be processed separately, to obtain the texture parameter of the image area. The texture parameter of the image area is a parameter characterizing an image area texture feature.

In some embodiments of the present disclosure, the image area texture feature parameter may be represented by a trace of a covariance matrix within the image area. Specifically, firstly, eigenvalues of the covariance matrix is obtained based on an intra-block gradient covariance matrix of each image area; and then, the eigenvalues of the covariance matrix are accumulated, to obtain the trace of the matrix as the texture parameter of the image area.

Step S1031C: taking an image area with the texture parameter less than a preset parameter threshold as the flat area of the video frame.

The greater texture parameter, the richer texture information in the image area is indicated. And the flat area is an image area in which texture features are not very rich, so that the image area with the texture parameter less than the preset parameter threshold can be taken as the flat area of the video frame.

Step S1032: performing an ADD operation on the flat area of the first video frame and the flat area of the second video frame, to obtain an intersection of the flat areas.

After the flat area of the first video frame and the flat area of the second video frame are obtained respectively, the ADD operation is performed on the flat areas of the two video frames, so that the intersection of the flat areas can be obtained. That is, if a pixel area at a specific position is the flat area in both the first video frame and the second video frame, the pixel area at the specific position can be taken as the intersection of the flat areas.

After the common minimum flat area is obtained, the computing device may perform step S104.

The video noise detection method comprises Step S104: calculating a time-domain noise value corresponding to the first video frame by using pixel information of the intersection of the flat areas in the inter-frame differential image.

In the embodiment of the present disclosure, after obtaining the intersection of the flat areas, the computing device may screen the pixel information in the inter-frame differential image by using the intersection of the flat areas, to determine a sub inter-frame differential image of the time-domain noise value. Subsequently, the time-domain noise value of the first video frame can be calculated by using pixel information of the sub inter-frame differential image.

FIG. 4 is a flow diagram of determining a time-domain noise value according to some embodiments of the present disclosure. As shown in FIG. 4, in some embodiments of the present disclosure, the pixel information in the step S104 includes pixel values of pixels of the intersection of the flat areas in the inter-frame differential image. In this case, the step S104 includes steps S1041-S1042.

Step S1041: calculating a weighted average of the pixel values of the pixels.

Step S1042: taking the weighted average as a time-domain noise value corresponding to a target timestamp.

In some embodiments of the present disclosure, a different pixel value (i.e., a gray value of a pixel) corresponds to a different weighted weight. At this time, in order to obtain the time-domain noise value corresponding to the target timestamp, first, it is needed to calculate the weighted average of the pixel values of the pixels, and then take the weighted average as the time-domain noise value corresponding to the target timestamp.

In a specific implementation, before the step S1041, the electronic device may further include step S1043.

Step S1043: determining weights respectively corresponding to the pixel values based on a preset correspondence between the pixel value and the weight.

In the embodiment of the present disclosure, the electronic device has therein stored the correspondence between each pixel value and the weight. After the pixel information of the intersection of the flat areas in the inter-frame differential image is acquired, the weights respectively corresponding to the pixel values may be determined based on the correspondence.

After determining the weight, the step S1041 may be performed. In a specific implementation, the step S1041 may include steps S1041A-S1042B.

Step S1041A: for each pixel value, calculating a product of the pixel value and the weight corresponding to the pixel value, to obtain a weighted pixel value corresponding to the pixel value.

Step S1041B: performing weighted average according to the weighted pixel values respectively corresponding to the pixel values, to obtain the weighted average.

For example, the pixel information of the intersection of the flat areas in the inter-frame differential image is x₁, x₂, . . . , xₙ, respectively, and the corresponding weights are ω₁, ω₂, . . . , ωₙ, then by using the steps S1041A-S1041B, the weighted average can be calculated using a formula

$$\frac{{ω}_{1} {x}_{1} + {ω}_{2} {x}_{2} + … + {ω}_{n} {x}_{n}}{{ω}_{1} + {ω}_{2} + … + {ω}_{n}} .$$

According to the video noise detection method according to the embodiments of the present disclosure, an inter-frame differential image and an intersection of flat areas are determined according to a first video frame and a second video frame adjacent in a target video, and then a time-domain noise value corresponding to the first video frame is calculated according to the intersection of the flat areas and pixel information in the frame differential image. Because the inter-frame differential image can evaluate a noise fluctuation feature of the video frame in a time domain, and the intersection of the flat areas is an image area with an obvious noise feature in the video frame, the noise feature of the intersection of the flat areas in the inter-frame differential image is obvious, so that the time-domain noise value calculated by using the pixel information of the intersection of the flat areas in the inter-frame differential image, can accurately evaluate the video frame noise in the time domain, thereby improving the accuracy of noise evaluation. In addition, with the method according to the embodiments of the present disclosure, since in the video noise detection method, the time-domain noise value of the video frame can be identified with only less processing amount, it can meet the requirement for real-time processing of the captured video.

In some embodiments of the present disclosure, after the time-domain noise value corresponding to the first video frame is calculated using the step S104, the video noise detection method may further include step S105.

Step S105: determining whether to perform noise reduction processing on the first video frame according to the time-domain noise value.

By determining whether to perform noise reduction processing on the first video frame according to the time-domain noise value, the noise reduction processing can be performed on the first video frame in response to the time-domain noise value exceeding a set value. And the noise reduction processing is not performed on the first video frame in response to the time-domain noise value not exceeding the set value.

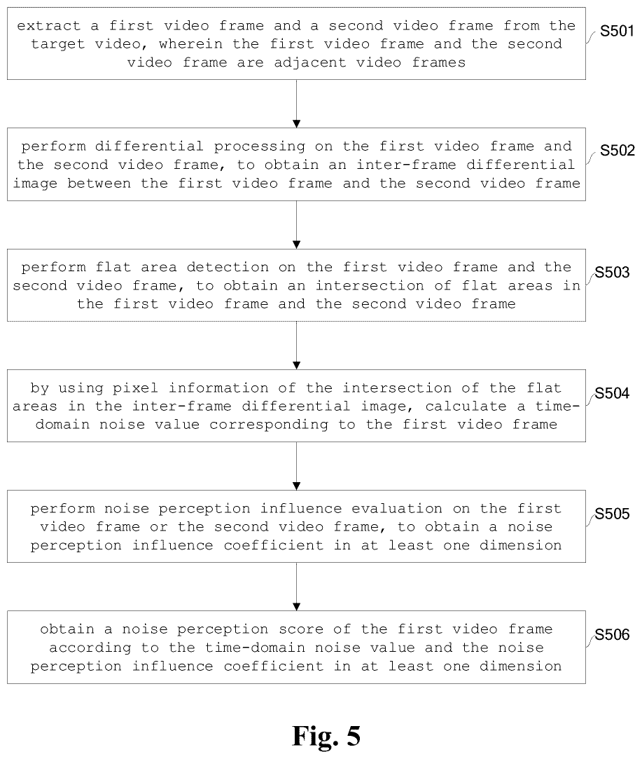

FIG. 5 is a flow diagram of a video noise detection method according to some other embodiments of the present disclosure. As shown in FIG. 5, in some embodiments of the present disclosure, the video noise detection method includes steps S501-S506.

Step S501: extracting a first video frame and a second video frame from a target video, wherein the first video frame and the second video frame are adjacent video frames

Step S502: performing differential processing on the first video frame and the second video frame, to obtain an inter-frame differential image between the first video frame and the second video frame.

Step S503: performing flat area detection on the first video frame and the second video frame, to obtain an intersection of flat areas in the first video frame and the second video frame.

Step S504: by using pixel information of the intersection of the flat areas in the inter-frame differential image, calculating a time-domain noise value corresponding to the first video frame.

The foregoing steps S501-S504 are identical with the steps S101-S104 in the foregoing embodiment, and reference can be made specifically to the foregoing description, which is not repeated herein.

Step S505: performing noise perception influence evaluation on the first video frame or the second video frame, to obtain a noise perception influence coefficient of at least one dimension.

In the embodiments of the present disclosure, the performing noise perception influence evaluation on the first video frame or the second video frame, to obtain a noise perception influence coefficient of at least one dimension, is to process the first video frame or the second video frame by using a pre-selected image evaluation method of a plurality of dimensions, to obtain the noise perception influence coefficient of at least one dimension. In the embodiments of the present disclosure, since the second video frame is the reference video frame, the noise perception influence evaluation is preferably performed on the second video frame in the step S505, to obtain the noise perception influence coefficient.

In some embodiments of the present disclosure, the noise perception influence coefficient may include at least one of a detail richness influence coefficient, a displacement rate influence coefficient, or a luminance influence coefficient.

The detail richness influence coefficient is an evaluation coefficient for characterizing an influence of image frame detail richness on noise perception. By performing detail intensity detection on the image frame, the detail richness influence coefficient may be obtained. In some embodiments of the present disclosure, the image frame may be processed by using Laplace transform, to obtain detail information of the image frame, and the detail richness influence coefficient is obtained using the detail information.

The displacement rate influence coefficient is an evaluation coefficient for evaluating an influence of object displacement rate on noise perception in the two video frames. In some embodiments of the present disclosure, image displacement detection may be performed on the first video frame and the second video frame, to obtain a displacement. The performing image displacement detection on the first video frame and the second video frame is to determine displacements of an object in the first video frame and the second video frame by performing feature extraction analysis on the first video frame and the second video frame, wherein the displacement may include a displacement in a length direction and a displacement in a width direction. Then, the displacement rate influence coefficient may be obtained based on the displacement and one of the first video frame or the second video frame. Taking an example of obtaining the displacement evaluation coefficient from the second video frame, the length displacement may be divided by an image length of the second video frame, to obtain a length direction rate influence coefficient, and the width displacement may be divided by an image width of the second video frame, to obtain a width direction rate influence coefficient. Finally, the displacement rate influence coefficient may be obtained according to the length direction rate influence coefficient and the width direction rate influence coefficient. Specifically, a root mean square may be solved by using the length direction rate influence coefficient and the width direction rate influence coefficient, to obtain the displacement rate influence coefficient.

The luminance influence coefficient is an evaluation coefficient for evaluating an influence of video frame luminance on noise perception. In some embodiments of the present disclosure, it is possible to count the number of pixels whose pixel gray value exceeds a set value in the video frame, and the counted number of pixels is divided by the total number of pixels in the video frame, to obtain an area proportion of a highlight area as the luminance influence evaluation coefficient.

Step S506: obtaining a noise perception score of the first video frame according to the time-domain noise value and the noise perception influence coefficient of at least one dimension.

After the time-domain noise value and the noise perception influence coefficient of at least one dimension are obtained, the noise perception score of the first video frame can be obtained according to a pre-specified scoring rule.

In some embodiments of the present disclosure, in terms of obtaining the video frame score according to the time-domain noise value and the noise perception influence coefficient of at least one dimension, it is possible to obtain a product by sequentially multiplying the time-domain noise value by each noise perception influence coefficient, and then take the product as the noise perception score of the first video frame.

In some other embodiments of the present disclosure, in terms of obtaining the noise perception score of the first video frame according to the time-domain noise value and the noise perception coefficient of at least one dimension, it is possible to obtain products by multiplying the time-domain noise value by each noise perception influence coefficient, respectively, and then add the products to obtain the noise perception score of the first video frame.

In other embodiments of the present disclosure, it is also possible to input the time-domain noise value and a noise perception influence coefficient of each dimension into a pre-trained deep learning scoring model, and perform comprehensive processing on the time-domain noise value and the noise perception influence coefficient of each dimension by using the deep learning scoring model, to obtain the noise perception score of the first video frame. The deep learning scoring model is trained by using sample images, and evaluation coefficients of dimensions and manually annotated scores that correspond to the sample images.

By obtaining the noise perception score of the first video using the time-domain noise value and the noise perception score of at least one dimension, it is possible to evaluate visual perception of noise in the first video frame, or determine whether to perform noise reduction processing on the first video frame.

The embodiment of the present disclosure further provides a video noise detection apparatus. The video noise detection apparatus may be provided in the foregoing computing device, to detect the target video noise.

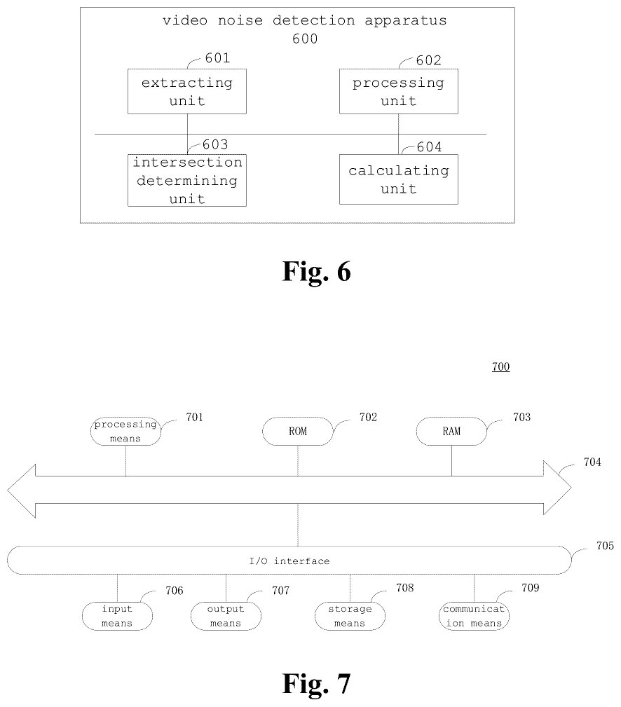

FIG. 6 is a schematic diagram of a video noise detection apparatus 600 according to an embodiment of the present disclosure, and as shown in FIG. 6, the video noise detection apparatus 600 according to the embodiment of the present disclosure may include an extracting unit 601, a processing unit 602, an intersection determining unit 603, and a calculating unit 604.

The extracting unit 601 is configured to extract a first video frame and a second video frame from a target video, wherein the first video frame and the second video frame are adjacent video frames.

The processing unit 602 is configured to perform differential processing on the first video frame and the second video frame, to obtain an inter-frame differential image between the first video frame and the second video frame.

The intersection determining unit 603 is configured to perform flat area detection on the first video frame and the second video frame, to obtain an intersection of flat areas in the first video frame and the second video frame.

The calculating unit 604 is configured to, by using pixel information of the intersection of the flat areas in the inter-frame differential image, calculate a time-domain noise value corresponding to the first video frame.

In some embodiments of the present disclosure, the pixel information comprises pixel values of pixels of the intersection of the flat areas in the inter-frame differential image. Correspondingly, the calculating unit 604 comprises a weighted average calculating subunit and a noise value calculating subunit. The weighted average calculating subunit is configured to calculate a weighted average of the pixel values of the pixels, and the noise value calculating subunit is configured to take the weighted average as a time-domain noise value corresponding to a target timestamp.

In some embodiments of the present disclosure, the calculating unit 604 further comprises a weight acquiring subunit, configured to determine weights respectively corresponding to the pixel values based on a preset correspondence between the pixel value and the weight. Correspondingly, the weighted average calculating subunit firstly calculates, for each pixel value, a product of the pixel value and the weight corresponding to the pixel value, to obtain a weighted pixel value corresponding to the pixel value; and then performs weighted average according to the weighted pixel values respectively corresponding to the pixel values, to obtain the weighted average.

In some embodiments of the present disclosure, the video noise detection apparatus 600 further comprises a noise perception influence coefficient acquiring unit and a noise perception score calculating unit. The noise perception influence coefficient acquiring unit is configured to perform noise perception influence evaluation on the first video frame and/or the second video frame, to obtain a noise perception influence coefficient of at least one dimension. A video frame scoring unit is configured to obtain a noise perception score of the first video frame according to the time-domain noise value and the noise perception influence coefficient of at least one dimension, wherein the noise perception score is used for evaluating visual perception of noise in the first video frame and/or whether to perform noise reduction processing on the first video frame.

In some embodiments of the present disclosure, the noise perception influence coefficient of at least one dimension comprises a detail richness influence coefficient, the performing noise perception influence evaluation on the first video frame or the second video frame, to obtain a noise perception evaluation coefficient of at least one dimension comprises: performing detail intensity detection on the first video frame or the second video frame, to obtain the detail richness influence coefficient.

In some embodiments of the present disclosure, the evaluation coefficient of at least one dimension comprises a displacement rate influence coefficient, and the performing noise perception influence evaluation on the first video frame or the second video frame, to obtain a noise perception evaluation coefficient of at least one dimension comprises: performing image displacement detection according to the first video frame and the second video frame, to obtain the displacement rate influence coefficient.

In some embodiments of the present disclosure, the evaluation coefficient of at least one dimension comprises a luminance influence coefficient, and the performing noise perception influence evaluation on the first video frame or the second video frame, to obtain a noise perception evaluation coefficient of at least one dimension comprises: performing highlight area detection on the first video frame or the second video frame, to obtain the luminance influence coefficient.

In some embodiments of the present disclosure, the detecting unit 603 comprises a flat area extracting subunit and an intersection determining subunit. The flat area extracting subunit is configured to, for any of the first video frame and the second video frame, perform flat area extraction on the video frame, to obtain the flat area of the video frame. The intersection determining subunit is configured to perform an AND operation on the flat area of the first video frame and the flat area of the second video frame, to obtain the intersection of the flat areas.

In some embodiments of the present disclosure, the flat area extracting subunit comprises an image area segmenting module, a texture parameter determining module, and a flat area selecting module. The image area segmenting module is configured to perform image segmentation on the video frame, to obtain a plurality of image areas of the video frame. The texture parameter determining module is configured to determine a texture parameter of each of the image areas. The flat area selecting module is configured to take an image area with the texture parameter less than a preset parameter threshold as the flat area of the video frame.

In some embodiments of the present disclosure, the video noise detection apparatus 600 further comprises an aligning unit. The aligning unit is configured to perform global alignment on the first video frame and the second video frame, to obtain aligned first video frame and second video frame. Correspondingly, the processing unit 602 performs a differential operation on the aligned first video frame and second video frame, to obtain the inter-frame differential image.

In some embodiments of the present disclosure, the aligning unit comprises a luminance aligning subunit, a coordinate transformation relation determining subunit, an affine transforming subunit, and an alignment video frame determining subunit. The aligning subunit is configured to perform luminance alignment processing on the first video frame and the second video frame, to obtain luminance-aligned first video frame and second video frame. The coordinate transformation relation determining subunit is configured to perform a phase alignment operation on the luminance-aligned first video frame and second video frame, to obtain a coordinate transformation relation between the first video frame and the second video frame. The affine transforming subunit is configured to perform affine transformation on the luminance-aligned first video frame by using the coordinate transformation relation, to obtain affine-transformed first video frame. The alignment video frame determining subunit is configured to take the affine-transformed first video frame as the aligned first video frame, and take the luminance-aligned second video frame as the aligned second video frame.

In some embodiments of the present disclosure, the coordinate transformation relation determining subunit comprises a down-sampling module, a phase alignment operating module, an original offset calculating module, and a coordinate transformation relation determining module. The down-sampling module is configured to perform down-sampling of a preset multiple on the luminance-aligned first video frame and second video frame, to obtain down-sampled first video frame and down-sampled second video frame. The phase alignment operating module is configured to perform a phase alignment operation on the down-sampled first video frame and the down-sampled second video frame, to obtain a rotation matrix and a down-sampling translation vector. The original offset calculating module is configured to multiply the down-sampling translation vector by the preset multiple, to obtain an original offset. The coordinate transformation relation determining module is configured to determine a coordinate transformation relation according to the rotation matrix and the original offset.

In some embodiments of the present disclosure, the video noise detection apparatus further comprises a noise reduction processing unit. The noise reduction processing unit is configured to determine whether to perform noise reduction processing on the first video frame according to the time-domain noise value.

It should be noted that the video noise detection apparatus 600 shown in FIG. 6 may perform the steps in the method embodiments shown in FIG. 1 to FIG. 5, and achieve the processes and effects in the method embodiments shown in FIG. 1 to FIG. 5, which are not repeated herein.

An embodiment of the present disclosure further provides a computing device, which may comprise a processor and a memory configured to store executable instructions. The processor may be configured to read the executable instructions from the memory and execute the executable instructions to implement the information displaying method in the foregoing embodiments.

FIG. 7 illustrates a schematic structural diagram of a computing device according to an embodiment of the present disclosure. Reference is specifically made to FIG. 7, which illustrates a schematic structural diagram of a computing device 700 suitable for implementing the embodiment of the present disclosure.

The computing device 700 in the embodiment of the present disclosure may be an electronic device or a server. Among them, the electronic device may include, but is not limited to, a mobile terminal such as a mobile phone, laptop computer, digital broadcast receiver, PDA (Personal Digital Assistant), PAD (Portable Android Device), PMP (Portable Multimedia Player), vehicle-mounted terminal (e.g., vehicle-mounted navigation terminal), and wearable device, and a fixed terminal such as a digital TV, desktop computer, and smart home device.

It should be noted that the computing device 700 shown in FIG. 7 is merely an example and should not bring any limitations to the function and use range of the embodiment of the present disclosure.

As shown in FIG. 7, the computing device 700 may comprise a processing means (e.g., central processing unit, graphics processing unit, etc.) 701, which may perform various appropriate actions and processes according to a program stored in a read-only memory (ROM) 702 or a program loaded from a storage means 708 into a random access memory (RAM) 703. In the RAM 703, various programs and data required for the operation of the information processing device 700 are also stored. The processing means 701, the ROM 702, and the RAM 703 are connected to each other via a bus 704. An input/output (I/O) interface 705 is also connected to the bus 704.

Generally, the following means may be connected to the I/O interface 705: an input means 706 including, for example, a touch screen, touch pad, keyboard, mouse, camera, microphone, accelerometer, gyroscope, etc.; an output means 707 including, for example, a liquid crystal display (LCD), speaker, vibrator, etc.; the storage means 708, including, for example, a magnetic tape, hard disk, etc.; and a communication means 709. The communication means 709 may allow the computing device 700 to communicate wirelessly or by wire with other devices to exchange data. While FIG. 7 illustrates the computing device 700 having various means, it should be understood that not all illustrated means are required to be implemented or provided. More or fewer means may be alternatively implemented or provided.

An embodiment of the present disclosure further provides a computer-readable storage medium having thereon stored a computer program which, when executed by a processor, causes the processor to implement the information displaying method in the above embodiment.

In particular, according to the embodiment of the present disclosure, the process described above with reference to the flow diagram may be implemented as a computer software program. For example, an embodiment of the present disclosure comprises a computer program product comprising a computer program carried on a non-transitory computer-readable medium, the computer program containing program code for performing the method illustrated by the flow diagram. In such an embodiment, the computer program may be downloaded and installed from a network via the communication means 709, or may be installed from the storage means 708, or may be installed from the ROM 702. The computer program, when executed by the processing means 701, performs the above functions defined in the information displaying method of the embodiment of the present disclosure.

It should be noted that the above computer-readable medium of the present disclosure may be a computer-readable signal medium or a computer-readable storage medium or any combination of the above two. The computer-readable storage medium may be, for example, but is not limited to, an electronic, magnetic, optical, electromagnetic, infrared, or semiconductor system, apparatus, or device, or any combination of the foregoing. More specific examples of the computer-readable storage medium may include, but are not limited to: an electrical connection having one or more wires, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing. In the present disclosure, the computer-readable storage medium may be any tangible medium containing or storing a program, wherein the program can be used by or in conjunction with an instruction execution system, apparatus, or device. However, in the present disclosure, the computer-readable signal medium may include a data signal propagated in baseband or as part of a carrier wave, in which computer-readable program code is carried. Such a propagated data signal may take a variety of forms, including, but not limited to, an electromagnetic signal, optical signal, or any suitable combination of the forgoing. The computer-readable signal medium may also be any computer-readable medium other than the computer-readable storage medium, wherein the computer-readable signal medium can send, propagate, or transmit a program for use by or in conjunction with an instruction execution system, apparatus, or device. The program code contained on the computer-readable medium may be transmitted using any appropriate medium, including but not limited to: a wire, an optical cable, RF (Radio Frequency), etc., or any suitable combination of the foregoing.

In some implementations, a client and a server may communicate using any currently known or future developed network protocol, such as HTTP, and may be interconnected with any form or medium of digital data communication (e.g., a communication network). Examples of the communication network include a local area network (“LAN”), a wide area network (“WAN”), an internet (e.g., the Internet), and a peer-to-peer network (e.g., an ad hoc peer-to-peer network), as well as any currently known or future developed network.

The above computer-readable medium may be contained in the above electronic device; or may exist separately without being assembled into the electronic device.

The above computer-readable medium has one or more programs carried thereon, which, when executed by the electronic device, cause the computing device to: extract a first video frame and a second video frame from a target video, wherein the first video frame and the second video frame are adjacent video frames; perform differential processing on the first video frame and the second video frame, to obtain an inter-frame differential image between the first video frame and the second video frame; perform flat area detection on the first video frame and the second video frame, to obtain an intersection of flat areas in the first video frame and the second video frame; and by using pixel information of the intersection of the flat areas in the inter-frame differential image, calculate a time-domain noise value corresponding to the first video frame.

In the embodiments of the present disclosure, computer program code for performing the operation of the present disclosure may be written in one or more programming languages or a combination thereof, wherein the above programming language includes but is not limited to an object-oriented programming language such as Java, Smalltalk, and C++, and also includes a conventional procedural programming language, such as a “C” language or a similar programming language. The program code may be executed entirely on a user's computer, partly on a user's computer, as a stand-alone software package, partly on a user's computer and partly on a remote computer, or entirely on a remote computer or server. In a scenario where a remote computer is involved, the remote computer may be connected to a user's computer through any type of network, including a local area network (LAN) or a wide area network (WAN), or may be connected to an external computer (for example, through the Internet using an Internet service provider).

The flow diagrams and block diagrams in the drawings illustrate the possibly implemented architecture, functions, and operations of the system, method and computer program product according to various embodiments of the present disclosure. In this regard, each block in the flow diagrams or block diagrams may represent a module, program segment, or portion of code, which includes one or more executable instructions for implementing a specified logical function. It should also be noted that, in some alternative implementations, functions noted in blocks may occur in a different order from those noted in the drawings. For example, two blocks shown in succession may, in fact, be executed substantially concurrently, or they may sometimes be executed in a reverse order, which depends upon the functions involved. It will also be noted that each block in the block diagrams and/or flow diagrams, and a combination of the blocks in the block diagrams and/or flow diagrams, can be implemented by a special-purpose hardware-based system that performs specified functions or operations, or by a combination of special-purpose hardware and computer instructions.

The involved units described in the embodiments of the present disclosure may be implemented by software or hardware. The name of the unit does not, in some cases, constitute a limitation on the unit itself.

The functions described above herein may be executed, at least partially, by one or more hardware logic components. For example, without limitation, a hardware logic component of an exemplary type that may be used includes: a field programmable gate array (FPGA), an application specific integrated circuit (ASIC), an application specific standard parts (ASSP), a system on chip (SOC), a complex programmable logic device (CPLD), and the like.

In the context of this disclosure, a machine-readable medium may be a tangible medium, which can contain or store a program for use by or in conjunction with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the foregoing. More specific examples of the machine-readable storage medium include an electrical connection based on one or more wires, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing.

The above only illustrates the preferred embodiments of the present disclosure and the technical principles employed. It should be appreciated by those skilled in the art that the disclosure scope involved in the present disclosure is not limited to the technical solutions formed by specific combinations of the technical features described above, but also encompasses other technical solutions formed by arbitrary combinations of the above technical features or equivalent features thereof without departing from the above disclosed concepts, for example, a technical solution formed by performing mutual replacement between the above features and technical features having similar functions to those disclosed (but not limited to) in the present disclosure.

Furthermore, while operations are depicted in a specific order, this should not be understood as requiring that these operations be performed in the specific order shown or in a sequential order. Under certain circumstances, multitasking and parallel processing might be advantageous. Similarly, while several specific implementation details are included in the above discussion, these should not be construed as limitations on the scope of the present disclosure. Certain features that are described in the context of separate embodiments may also be implemented in combination in a single embodiment. Conversely, various features that are described in the context of a single embodiment may also be implemented in multiple embodiments separately or in any suitable sub-combination.

Although the subject matter has been described in language specific to structural features and/or method logical actions, it should be understood that the subject matter defined in the attached claims is not necessarily limited to the specific features or actions described above. Rather, the specific features and actions described above are only example forms of implementing the claims.

What is claimed is:

1. A video noise detection method, comprising:
extracting a first video frame and a second video frame from a target video, wherein the first video frame and the second video frame are adjacent video frames;
performing differential processing on the first video frame and the second video frame, to obtain an inter-frame differential image between the first video frame and the second video frame;
performing flat area detection on the first video frame and the second video frame, to obtain an intersection of flat areas in the first video frame and the second video frame; and
calculating a time-domain noise value corresponding to the first video frame by using pixel information of the intersection of the flat areas in the inter-frame differential image.

2. The video noise detection method according to claim 1, wherein the pixel information comprises pixel values of pixels of the intersection of the flat areas in the inter-frame differential image, and the calculating a time-domain noise value corresponding to the first video frame by using pixel information of the intersection of the flat areas in the inter-frame differential image comprises:
calculating a weighted average of the pixel values of the pixels; and
taking the weighted average as the time-domain noise value corresponding to the first video frame.

3. The video noise detection method according to claim 2, further comprising:
before the calculating a weighted average of the pixel values of the pixels, determining weights respectively corresponding to the pixel values based on a preset correspondence between the pixel value and the weight.

4. The video noise detection method according to claim 3, wherein the calculating a weighted average of the pixel values of the pixels comprises:
for each pixel value, calculating a product of the pixel value and the weight corresponding to the pixel value, to obtain a weighted pixel value corresponding to the pixel value; and
performing weighted average calculation according to the weighted pixel values respectively corresponding to the pixel values, to obtain the weighted average.

5. The video noise detection method according to claim 1, further comprising:
perform noise perception influence evaluation on at least one of the first video frame or the second video frame, to obtain a noise perception influence coefficient in at least one dimension.

6. The video noise detection method according to claim 5, further comprising:
after the calculating a time-domain noise value corresponding to the first video frame by using pixel information of the intersection of the flat areas in the inter-frame differential image, obtaining a noise perception score of the first video frame according to the time-domain noise value and the noise perception influence coefficient of at least one dimension, the noise perception score being configured for evaluating visual perception of noise in the first video frame and/or whether to perform noise reduction processing on the first video frame.

7. The video noise detection method according to claim 5, wherein:
the noise perception influence coefficient of at least one dimension comprises a detail richness influence coefficient, and the performing noise perception influence evaluation on the first video frame or the second video frame, to obtain a noise perception evaluation coefficient in at least one dimension, comprises: performing detail intensity detection on the first video frame or the second video frame, to obtain the detail richness influence coefficient; and/or
the evaluation coefficient of at least one dimension comprises a displacement rate influence coefficient, and the performing noise perception influence evaluation on the first video frame or the second video frame, to obtain a noise perception evaluation coefficient of at least one dimension, comprises: performing image displacement detection according to the first video frame and the second video frame, to obtain the displacement rate influence coefficient; and/or
the evaluation coefficient of at least one dimension comprises a luminance influence coefficient, and the performing noise perception influence evaluation on the first video frame or the second video frame, to obtain a noise perception evaluation coefficient of at least one dimension, comprises: performing highlight area detection on the first video frame or the second video frame, to obtain the luminance influence coefficient.

8. The video noise detection method according to claim 1, wherein the performing flat area detection on the first video frame and the second video frame, to obtain an intersection of flat areas in the first video frame and the second video frame, comprises:
for any of the first video frame and the second video frame, performing flat area extraction on the video frame, to obtain the flat area of the video frame; and
performing an AND operation on the flat area of the first video frame and the flat area of the second video frame, to obtain the intersection of the flat areas.

9. The video noise detection method according to claim 8, wherein the performing flat area extraction on the video frame, to obtain the flat area of the video frame, comprises:
performing image segmentation on the video frame, to obtain a plurality of image areas of the video frame;
determining a texture parameter of each of the image areas; and
taking an image area with the texture parameter less than a preset parameter threshold as the flat area of the video frame.

10. The video noise detection method according to claim 1, further comprising:
before the performing differential processing on the first video frame and the second video frame, to obtain an inter-frame differential image between the first video frame and the second video frame, performing global alignment on the first video frame and the second video frame, to obtain aligned first video frame and second video frame.

11. The video noise detection method according to claim 10, wherein the performing differential processing on the first video frame and the second video frame, to obtain an inter-frame differential image between the first video frame and the second video frame, comprises:
performing a differential operation on the aligned first video frame and second video frame, to obtain the inter-frame differential image.

12. The video noise detection method according to claim 10, wherein the performing global alignment on the first video frame and the second video frame, to obtain aligned first video frame and second video frame, comprises:
performing luminance alignment processing on the first video frame and the second video frame, to obtain luminance-aligned first video frame and second video frame;
performing a phase alignment operation on the luminance-aligned first video frame and second video frame, to obtain a coordinate transformation relation between the first video frame and the second video frame;
performing affine transformation on the luminance-aligned first video frame by using the coordinate transformation relation, to obtain affine-transformed first video frame; and
taking the affine-transformed first video frame as the aligned first video frame, and taking the luminance-aligned second video frame as the aligned second video frame.

13. The video noise detection method according to claim 12, wherein the performing a phase alignment operation on the luminance-aligned first video frame and second video frame, to obtain a coordinate transformation relation between the first video frame and the second video frame, comprises:
performing down-sampling of a preset multiple on the luminance-aligned first video frame and second video frame, to obtain down-sampled first video frame and down-sampled second video frame;
performing a phase alignment operation on the down-sampled first video frame and the down-sampled second video frame, to obtain a rotation matrix and a down-sampling translation vector;
multiplying the down-sampling translation vector by the preset multiple, to obtain an original offset; and
determining the coordinate transformation relation according to the rotation matrix and the original offset.

14. The video noise detection method according to claim 1, further comprising:
after the calculating a time-domain noise value corresponding to the first video frame, determining whether to perform noise reduction processing on the first video frame according to the time-domain noise value.

15. The video noise detection method according to claim 1, wherein the performing differential processing on the first video frame and the second video frame, to obtain an inter-frame differential image between the first video frame and the second video frame, comprises:
subtracting gray values of pixels in the first video frame from gray values of pixels in the second video frame at corresponding positions of the first video frame, respectively, to obtain pixel gray differences; and
taking an image formed by the pixel gray differences in a ranking order of corresponding pixels in the first video frame and the second video frame, as the inter-frame differential image between the first video frame and the second video frame.

16. (canceled)

17. A computing device, comprising:
a processor; and
a memory configured to store executable instructions,
wherein the processor is configured to read the executable instructions from the memory and execute the executable instructions to implement a video noise detection method comprising:
extracting a first video frame and a second video frame from a target video, wherein the first video frame and the second video frame are adjacent video frames;
performing differential processing on the first video frame and the second video frame, to obtain an inter-frame differential image between the first video frame and the second video frame;
performing flat area detection on the first video frame and the second video frame, to obtain an intersection of flat areas in the first video frame and the second video frame; and
calculating a time-domain noise value corresponding to the first video frame by using pixel information of the intersection of the flat areas in the inter-frame differential image.

18. A non-transitory computer-readable storage medium having thereon stored a computer program which, when executed by a processor, causes the processor to perform a video noise detection method comprising:
extracting a first video frame and a second video frame from a target video, wherein the first video frame and the second video frame are adjacent video frames;
performing differential processing on the first video frame and the second video frame, to obtain an inter-frame differential image between the first video frame and the second video frame;
performing flat area detection on the first video frame and the second video frame, to obtain an intersection of flat areas in the first video frame and the second video frame; and
calculating a time-domain noise value corresponding to the first video frame by using pixel information of the intersection of the flat areas in the inter-frame differential image.

19. (canceled)

20. The computing device according to claim 17, wherein the pixel information comprises pixel values of pixels of the intersection of the flat areas in the inter-frame differential image, and the calculating a time-domain noise value corresponding to the first video frame by using pixel information of the intersection of the flat areas in the inter-frame differential image comprises:
calculating a weighted average of the pixel values of the pixels; and
taking the weighted average as the time-domain noise value corresponding to the first video frame.

21. The non-transitory computer-readable storage medium according to claim 18, wherein the pixel information comprises pixel values of pixels of the intersection of the flat areas in the inter-frame differential image, and the calculating a time-domain noise value corresponding to the first video frame by using pixel information of the intersection of the flat areas in the inter-frame differential image comprises:
calculating a weighted average of the pixel values of the pixels; and
taking the weighted average as the time-domain noise value corresponding to the first video frame.
